(19) United States
(12) Patent Application Publication
(10) Pub. No.: US 2024/0376671 A1
(43) Pub. Date: Nov. 14, 2024

(54) RECYCLABLE COMPOSITE HAVING DISSOLVABLE POLYMER LAYER, METHOD FOR FABRICATING, AND USE WITH FOOD CONTAINERS

(71) Applicant: Ahlstrom Oyj, Helsinki (FI)

(72) Inventors: Corey Bishop, Kaukauna, WI (US); Josh Lorge, Kaukauna, WI (US)

(21) Appl. No.: 18/690,464

(22) PCT Filed: Sep. 10, 2021
(86) PCT No.: PCT/IB2021/058265

§ 371 Date: Mar. 8, 2024

(51) Int. Cl. D21H 19/20; B65D 30/08; D21H 21/18

(52) U.S. Cl. CPC D21H 19/20; B65D 31/02; D21H 21/18

(57) ABSTRACT

Disclosed herein are advantageous recyclable composites having a dissolvable polymer layer, and related methods of fabrication and use thereof. The present disclosure provides recyclable composites having a dissolvable polymer layer, and systems/methods for fabricating the recyclable composites and systems/methods for utilizing recyclable composites with food containers. More particularly, the present disclosure provides advantageous recyclable composites having a paper substrate and a dissolvable polymer layer on the paper substrate, wherein the recyclable composite is configured and dimensioned to be positioned relative to a food container vessel for use with the food container vessel, the recyclable composite suitable for coming into contact with food.

### FIELD OF THE DISCLOSURE

The present disclosure relates to recyclable composites having a dissolvable polymer layer and systems/methods for fabricating the recyclable composites and systems/methods for utilizing recyclable composites with food containers and, more particularly, to recyclable composites having a paper substrate and a dissolvable polymer layer on the paper substrate, wherein the recyclable composite is configured and dimensioned to be positioned relative to a food container vessel for use with the food container vessel, the recyclable composite suitable for coming into contact with food.

### BACKGROUND OF THE DISCLOSURE

In general, some food containers or the like are known. For example. conventional paper based pet food bags can have a plastic film/liner (e.g., polypropylene) positioned on the food bags, thereby rendering the food bags non-recyclable. In general, conventional paper based pet food bags are not recyclable due to their plastic film/liner.

An interest exists for food containers that are at least partially recyclable.

These and other inefficiencies and opportunities for improvement are addressed and/or overcome by the composites, assemblies and methods of the present disclosure.

### BRIEF SUMMARY OF THE DISCLOSURE

The present disclosure provides advantageous recyclable composites having a dissolvable polymer layer, and systems/methods for fabricating the recyclable composites and systems/methods for utilizing recyclable composites with food containers. More particularly, the present disclosure provides advantageous recyclable composites having a paper substrate and a dissolvable polymer layer on the paper substrate, wherein the recyclable composite is configured and dimensioned to be positioned relative to a food container vessel for use with the food container vessel, the recyclable composite suitable for coming into contact with food.

The above described and other features are exemplified by the following figures and detailed description.

Any combination or permutation of embodiments is envisioned. Additional advantageous features, functions and applications of the disclosed composites, assemblies and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following figures are exemplary embodiments wherein the like elements are numbered alike.

Features and aspects of embodiments are described below with reference to the accompanying drawings, in which elements are not necessarily depicted to scale.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed composites, assemblies and methods, reference is made to the appended figures, wherein:

FIG. 1 is a side view of an exemplary recyclable composite having a dissolvable polymer layer, according to the present disclosure.

FIG. 2 is a top view of an exemplary food container vessel for use with the recyclable composites of the present disclosure.

### DETAILED DESCRIPTION OF THE DISCLOSURE

The exemplary embodiments disclosed herein are illustrative of advantageous recyclable composites having a dissolvable polymer layer, and systems of the present disclosure and methods/techniques thereof. It should be understood, however, that the disclosed embodiments are merely exemplary of the present disclosure, which may be embodied in various forms. Therefore, details disclosed herein with reference to exemplary recyclable composites and associated processes/techniques of assembly and use are not to be interpreted as limiting, but merely as the basis for teaching one skilled in the art how to make and use the advantageous recyclable composites and/or alternative composites of the present disclosure.

Disclosed herein are advantageous recyclable composites having a dissolvable polymer layer, and related methods of fabrication and use thereof.

The present disclosure provides improved recyclable composites having a dissolvable polymer layer, and improved systems/methods for utilizing and fabricating the recyclable composites.

More particularly, the present disclosure provides advantageous recyclable composites having a paper substrate and a dissolvable polymer layer on the paper substrate, wherein the recyclable composite is configured and dimensioned to be positioned relative to a food container vessel for use with the food container vessel, the recyclable composite suitable for coming into contact with food.

Referring now to the drawings, like parts are marked throughout the specification and drawings with the same reference numerals, respectively. Drawing figures are not necessarily to scale and in certain views, parts may have been exaggerated for purposes of clarity.

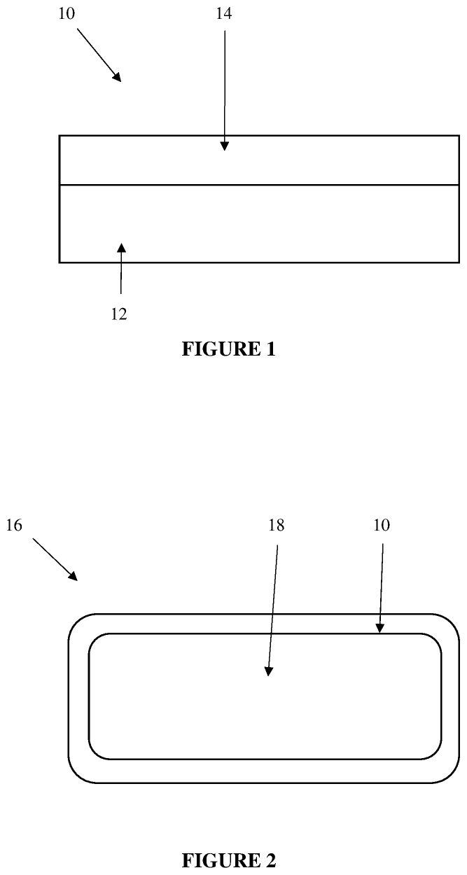

As shown in FIG. 1, there is illustrated a side view of an exemplary recyclable composite 10 having a dissolvable polymer layer 14 on a substrate 12 (e.g., paper substrate 12).

FIG. 2 depicts a top view of an exemplary food container vessel 16 for use with a recyclable composite 10 of the present disclosure.

In exemplary embodiments, the present disclosure provides recyclable composites 10 having a paper substrate 12 and a dissolvable polymer layer 14 on the paper substrate 12, wherein the recyclable composite 10 is configured and dimensioned to be positioned relative to a food container vessel 16 for use with the food container vessel 16, the recyclable composite 10 suitable for coming into contact with food.

The present disclosure further provides for a method for fabricating a composite 10 suitable for a food container vessel 16 including providing a dissolvable polymer layer 14 on a paper substrate 12 to define a recyclable composite 10, with the recyclable composite 10 configured and dimensioned to be positioned relative to the food container vessel 16 for use with the food container vessel 16, the recyclable composite 10 suitable for coming into contact with food.

In example embodiments and as shown in FIG. 2, the food container vessel 16 defines an inner cavity 18, and the recyclable composite 10 is configured and dimensioned to be positioned proximal or next to the inner cavity 18 (e.g., with the dissolvable polymer layer 14 facing inwards toward the inner cavity 18 and acting as a grease barrier for vessel 16). In some embodiments, the food container vessel 12 is a pet food bag/vessel 12, the inner cavity 18 of the pet food bag/vessel 12 configured and dimensioned to house pet food, with the pet food comprising grease or oil, although the present disclosure is not limited thereto. Rather, it is noted that food container vessel 16 can take a variety of forms and/or shapes (e.g., configured and dimensioned to house other types of food for other types of users). It is noted that the food container vessel 16 can be a dry food packaging container vessel 16. For example, vessel 16 can be a paper bag/vessel 16 that is in contact with dry food that has a high amount of grease/oil (e.g., pet food).

In some embodiments, the present disclosure provides for a food container vessel 16 defining an inner cavity 18 and having an inner liner comprised of composite 10 positioned proximal to the inner cavity 18 (e.g., with the dissolvable polymer layer 14 of composite/inner liner 10 facing inwards toward the inner cavity 18 and acting as a grease barrier for vessel 16).

As noted, conventional paper based pet food bags can have a plastic film/liner (e.g., polypropylene on the inside of a multi-layer paper bag) positioned on the food bags, thereby rendering the food bags non-recyclable. As such, conventional paper based pet food bags are not recyclable due to their plastic film/liner. The present disclosure advantageously provides recyclable composites 10 having a paper substrate 12 and a dissolvable polymer layer 14 on the paper substrate 12, wherein the recyclable composite 10 is configured and dimensioned to be positioned relative to a food container vessel 16 for use with the food container vessel 16 (e.g., with the recyclable composite 10 positioned proximal or next to the inner cavity 18), thereby making the vessel 16 recyclable, which thereby provides significant manufacturing, commercial and/or environmental benefits and advantages as a result.

It is noted that the recyclable composite 10 can be attached to one or more additional layers of the food container vessel 16 (e.g., pet food bag/vessel 16), and the one or more additional layers can comprise paper or the like.

As shown in FIG. 1, recyclable composite 10 includes a dissolvable polymer layer 14 on a substrate 12. In exemplary embodiments, substrate 12 is a paper substrate 12, although the present disclosure is not limited thereto. Rather, it is noted that substrate 12 can take a variety of forms and/or shapes.

In exemplary embodiments, the dissolvable polymer layer 14 comprises polyvinyl alcohol, although the present disclosure is not limited thereto. For example, the dissolvable polymer layer 14 can comprise at least one of polyvinyl alcohol or plasticized plant starch (e.g., plasticized corn, tapioca or potato starch, etc.).

The dissolvable polymer layer 14 can be a laminated layer 14 or an extruded layer 14. For example, providing the dissolvable polymer layer 14 on the paper substrate 12 to define the recyclable composite 10 can comprise laminating (e.g., blown film laminating) or extruding (e.g., extrusion coating) the dissolvable polymer layer 14 with respect to the paper substrate 12 (e.g., laminating or extruding the dissolvable polymer layer 14 directly on the paper substrate 12).

In exemplary embodiments, the recyclable composite 10 is grease resistant and heat scalable, and meets U.S. FDA requirements 21 CFR 176.170 and 21 CFR 176.180 for direct food contact. The recyclable composite 10 includes favorable strength properties, as discussed further below.

It is noted that the dissolvable polymer layer 14 can have a thickness of from about 1 micron to about 40 microns on substrate 12, preferably a thickness of from about 10 to about 30 microns, more preferably a thickness of from about 20 to about 28 microns on substrate 12.

In certain embodiments, the dissolvable polymer layer 14 is warm water soluble at 40° C. It is noted that the recyclable composite 10 can be re-pulpable at 40° C. or higher. The dissolvable polymer layer 14 can be biodegradable and water soluble. The dissolvable polymer layer 14 can be soluble in 60° C. tap water in less than 60 seconds.

As noted, the dissolvable polymer layer 14 can comprise polyvinyl alcohol. The polyvinyl alcohol of dissolvable polymer layer 14 can comprise partially hydrolyzed polyvinyl acetate with a degree of hydrolysis between 70% to 95%, preferably between 75% to 92% (e.g., 70 to 95% percent saponified, preferably 75 to 92% percent saponified).

The dissolvable polymer layer 14 can be directly attached to the substrate 12 (e.g., paper substrate 12). In example embodiments, the dissolvable polymer layer 14 of composite 10 has a basis weight of from about 10 to about 60 grams per square meter (gsm) on substrate 12, preferably a basis weight of from about 15 to 45 gsm.

The dissolvable polymer layer 14 can have an oxygen transmission rate of less than 10 cm³/m²/day at 23° C. and 50% relative humidity.

In exemplary embodiments, the recyclable composite 10 is oil and grease resistant, and passes the Creased accelerated pet food test. The recyclable composite 10 can be recyclable according to EN13430. In certain embodiments, the recyclable composite 10 is oil and grease resistant at Kit Test Level 12 or above, as tested by TAPPI T559.

In example embodiments, the recyclable composite 10 is free of fluoro-chemicals and is free of biaxially oriented polypropylene or the like.

In some embodiments, the recyclable composite 10 comprises at least one fold, the at least one fold of the recyclable composite 10 resistant to grease.

In non-limiting examples, substrate 12 takes the form of a paper substrate 12.

Paper substrate 12 can comprise cellulosic or cellulose fibers. For example, the paper substrate 12 can comprise at least 50 weight % cellulosic or cellulose fibers, based on the total weight of the substrate 12.

The paper substrate 12 can have a basis weight of from about 30 grams per square meter (gsm) to about 100 gsm, preferably from about 40 to about 70 gsm, more preferably from about 40 to about 50 gsm.

The paper substrate 12 can be fabricated from Kraft pulp. The paper substrate 12 can comprise natural Kraft paper.

In exemplary embodiments, paper substrate 12 can comprise smooth machine glazed natural Kraft paper (30 pound/ream (49 gsm)), with the substrate 12 laminated or extrusion coated with a layer (e.g., 20 to 25 micron layer) of the dissolvable polymer layer 14.

Certain exemplary composites 10 were tested for holdout of pet food materials, strength, heat seal and recyclability. The tested composites 10 passed all of the tests important for pet food. The tested composites 10 passed recyclability tests.

In exemplary embodiments, the exemplary composites 10 have grease resistance and grease resistance at the folds of vessel 16, which can be important for food packaging of oily/greasy substances.

It is noted that some customers in the pet food industry are also increasingly interested in sustainable solutions, so packaging that is more eco-friendly (e.g., vessel 16 with recyclable composite 10) is preferred.

In exemplary embodiments, the present disclosure provides for a paper-based laminate/composite 10 that comprises two layers (substrate 12 and dissolvable polymer layer 14). The composite 10 can be used as an inner liner in pet food bags 16. It is noted that the composite 10 can also be used for other dry food packaging/vessels 16 with food that has high amounts of grease/oil, e.g., butter wrapping. The composite 10 can comprises a dissolvable polyvinyl alcohol (PVOH or PVA) plastic film 14 extruded or laminated onto a paper substrate 12. The paper substrate 12 can be comprised of Kraft cellulose pulp and can have a basis weight between 30 to 100 gsm, preferably 40 to 70 gsm. An exemplary PVOH film 14 is warm water-soluble with solubility in 60° C. tap water in less than 60 seconds. The PVOH film 14 can be fabricated from partially hydrolyzed polyvinyl acetate with a degree of hydrolysis between 70% to 95%, preferably between 75% to 92%. The PVOH film 14 can have a thickness of up to 40 microns, preferably up to 30 microns, and more preferably between 10 to 25 microns. The inner liner/composite 10 formed from the paper based laminate/composite 10 is recyclable according to EN13430, heat-scalable and has an exceptional level of oil/grease resistance (e.g., Kit test level 12 or above), and passes the Creased accelerated pet food test.

Pet food typically includes high amounts of oil and fats (e.g., omega-3 fatty acids, linoleic acid, etc., which provide the necessary nutrients for the pet). So, the food packaging vessel 16 typically needs a grease/oil barrier coating. Otherwise, grease will penetrate through the packaging material of vessel 16, and grease stains then appear on the outer surface of the bag 16. It can be important that the inner material 10 of the pet food bag 16 both protects the food content within and also acts as a grease barrier. Grease penetration is not just visually unappealing; it also causes the bag 16 to lose structural integrity and increases risk of breakage when being handled. So, the inner liner material 10 in pet food bags should have an excellent grease barrier, including at the folds of the bag (Kit level of 12 or above, as tested by TAPPI T559. The Turpentine Test TAPPI T454 standard is also used to measure grease resistance).

The bag 16 should also be strong enough to withstand handling. It is especially important that the inner liner material/composite 10 has sufficient tear strength/tear resistance so that it does not weaken when folded to form the pet food bag/vessel 16. The tear strength and stretch of the product/composite 10, especially in the cross-direction, is a measure of how well it can withstand the effects of tearing. It is noted that if the bag/vessel 16 is dropped it should not burst open. High burst strength of inner liner material/composite 10 of bag/vessel 16 is desirable (e.g., Mullen burst of around 50 psi or greater). High CD tensile of inner liner material/composite 10 of bag/vessel 16 is desirable (e.g., CD tensile of around 25 lbf/in. or greater). High CD tear strength of inner liner material/composite 10 of bag/vessel 16 is desirable (e.g. CD tear strength of 100 gram force or greater).

The pet food bag material/composite 10 should also be fabricated from materials that are safe for food contact. The product/composite 10 should meet U.S. FDA requirements for direct-food contact and/or other equivalent standards in other countries. The composite 10 of bag 16 should preferably be heat sealable. This helps in closing/sealing the bag 16. In general, the bag 16 is recyclable in addition to these properties.

In exemplary embodiments, composite 10 is a two-layer composite 10. Some exemplary product design of pet food bag liner/composite 10 comprises a paper 12 made of 100% cellulose fibers and may optionally contain binder/additives.

While the paper substrate 12 may be typically made of Kraft pulp, other types of cellulose fibers may also be used. In general, cellulose fibers include cellulose fibers from manmade sources (for example, regenerated cellulose fibers or lyocell fibers) or natural sources such as cellulose fibers or cellulose pulp from woody and non-woody plants. Woody plants include, for example, deciduous and coniferous trees. Nonwoody plants include, for example, cotton, flax, esparto grass, kenaf, sisal, abaca, milkweed, straw, jute, hemp, and bagasse. Preferably, the cellulose fibers in the paper 12 are wood pulp based and comprise hardwood and/or softwood fibers. The paper 12 may also comprise binders or additives (e.g., strength additives such as, for example, starch; sizing additives such as, for example, rosin or AKD; talc, etc.). Preferably, the paper layer 12 is recyclable and/or biodegradable.

The paper substrate 12 can be laminated or extrusion coated with a dissolvable polymer layer 14 (e.g., dissolvable PVOH film 14), the film 14 being warm water-soluble with solubility in 60° C. (140° F.) tap water in less than 60 seconds. In some embodiments, the polymer layer 14 is fabricated from partially hydrolyzed PVOH with a degree of hydrolysis between 70% to 95%, preferably between 75% to 92%.

In exemplary embodiments, the dissolvable polymer film 14 is warm water soluble at 40° C. (104° F.). Since an exemplary recyclability test was done at 140° F., the PVOH film 14 completely dissolved during the test, which allowed the composite 10 to pass the test.

As discussed further below, the recyclability of the film 14 was analyzed (using EN13430 standard) and an internal test. The products/composites 10 were tested for heat-scalability at 400° F. and 60 psi; mechanical properties of the laminated paper/composite 10 showed good tear strength and % stretch. The tests showed laminated paper/composite 10 had low oxygen transmission rate (OTR), which is another advantageous feature of this composite 10. Pet food testing results are shown for exemplary composites 10 below. The dissolvable film side of the composite structure 10 heat sealed well to itself at 400F and 60 psi.

As noted, the paper layer 12 can be fabricated from multiple types of fibers although Kraft pulp can be preferred. The paper layer 12 is fabricated preferably via a wetlaid process and can optionally be calendared. Binders and/or additives could be added during or after the paper-making process for substrate 12. For example, strength additives can be added to substrate 12 to increase the wet or dry strength of the paper 12. Other additives or binders could provide water resistance (hydrophobicity) or grease resistance to the paper layer 12.

The composite 10 can have additional layers, although two-layers (12; 14) is preferred.

The film layer 14 can be extrusion coated directly onto the paper layer 12. Alternatively, a blown film 14 (e.g., PVOH film 14) can be separately formed and laminated onto the paper layer 12.

Some advantageous features include, without limitation: the film layer 14 is made from a warm-water soluble PVOH 14 (e.g., optimal solubility 40 to 60° C., solubility in 60° C. tap water in less than 60 sec), and which is partially hydrolyzed (e.g., degree of hydrolysis between 70% to 95%, preferably between 75% to 92%); the film layer 14 provides heat-scalability and grease-resistance to the laminate/composite 10; the film/layer 14 also dissolves in water making the laminated paper composite 10 recyclable; the two-layer (12; 14) design of the film 14 and the paper-based substrate 12, which provides the laminate 10 with sufficient tear strength and stretch (and low oxygen transmission rate).

This disclosure is further illustrated by the following examples, which are non-limiting.

### EXAMPLE 1

A 40 lbs/ream of cellulose pulp paper (made with 100% Kraft cellulose) was laminated to a 25 micron PVOH blown film (14) of HydroPol™ 33100 from Aquapak. The laminate (10) had improved mechanical strength (tear strength more than doubles) and exceptional grease resistance (Kit level of 12). Unlike the paper (40 lbs Nat Kraft in Table 1), the laminate/composite (40 lbs Nat Kraft w/ 25 micron PVOH film in Table 1) passed the creased accelerated pet food test, was heat-sealable and also advantageously had a low oxygen transmission rate. See Table 1 below. In Table 1 “MD” is machine direction; “CD” is cross-machine direction; and “OTR” is oxygen transmission rate.

TABLE 1

| | | | | 40 lbs Nat |
|---|---|---|---|---|
| | | | | Kraft w/25 |
| | | | 40 lbs Nat | micron |
| Test | Units | Tappi Test # | Kraft | PVOH film |
| Basis weight | lbs/3000 sq. ft | Tappi T - 410 | 40 | 67.9 |
| Tensile MD | lbf/in. | Tappi T-494 | 48.24 | 48 |
| Tensile CD | lbf/in. | Tappi T-494 | 17.13 | 25 |
| Stretch CD | % | Tappi T-494 | 4.2 | 3.6 |
| Stretch MD | % | Tappi T-494 | 2.3 | 2.5 |
| Mullen | psi | Tappi T-403 | 50.2 | 57.2 |
| Tear CD | Grams Force | Tappi T 414 | 52.0 | 189 |
| Tear MD | Grams Force | Tappi T 414 | 39.2 | 108 |
| Recyclability | % Yield after | EN 13430 | 99.8 | 99 |
| | screening | | | |
| | Visual Aspect | | 5 | 5 |
| | of Handsheets | | | |
| | Recyclability | | Recyclable | Recyclable |
| | assessment | | | |
| Kit level Coated | 3M Kit # | Tappi T 559 | 0 | 12 |
| side | | | | |
| Tappi Turpentine | time | Tappi T454 | 0 | Greater than |
| | | | | 24 hours |
| Creased | Time until | Internal Test | Less than | Greater than |
| Accelerated Pet | greater than | | 1 hour | 14 days |
| Food test | 5% failure | | | |
| OTR (cc/m² · day) | cc/m² · day | ASTM D3985 | | 5.5 |
| 23° C. 50% HR | | | | |
| Heat Seal Temp. | | ASTM F2029 | | 400 |

### EXAMPLE 2

Comparative examples were made with paper coated with liquid PVOH. The 40 lbs/ream cellulose pulp paper (made with 100% Kraft cellulose) mentioned above was coated with the aqueous coating comprising partially hydrolyzed PVOH S-1505P-L from Synthetic Natural Polymers. Two comparative examples were made with the PVOH coated on one-side at different coat weights (See Table 2-Conditions 2 and 3). Also included in Table 2 is a comparative example of a conventional pet food bag liner made of paper and polypropylene film. The conventional liner is a two-layer laminate, and it is not recyclable and also does not have the strength of the exemplary Condition 1 composite example in Table 2. Even when the difference in basis weight is taken into account of Conventional liner versus the exemplary Condition 1 composite, (e.g., by taking the mechanical strength value and dividing by the basis weight), the exemplary Condition 1 composite has higher tensile and tear strength per unit weight than the conventional liner.

The example composite of the present disclosure (Condition #1: 40 lbs w/ 25 micron PVOH film in Table 2 below) had higher tear strength and superior grease holdout when measured by Kit test, Tappi Turpentine and an internal accelerated pet food test to test grease resistance of a creased/folded material. In exemplary embodiments, the following ranges quantify the required strength properties: Mullen greater than 50 psi; MD tear greater than 70 grams force; CD tear greater than 100 grams force; CD tensile greater than 20 lbf/in. CD tensile, tear strength and Mullen burst are important properties to determine quantify the integrity of the bag. It should have at least the above-noted minimum strength in order to prevent accidental ruptures during converting or handling. In general, the minimum acceptable performance for creased accelerated pet food test is 14 days (e.g., the bag should be grease-resistant at the folds for at least 14 days). Moreover, the TAPPI Turpentine should be greater than 24 hours, in order to meet the required grease-resistance at end-use.

TABLE 2
PVOH = S-1505P-L (partially Hydrolyzed) from Synthetic Natural Polymers.
Conventional pet food bag liner = 40 lbs/3000 sq. ft Kraft paper laminated
to 11 lbs/3000 sq. ft and 10 micron film of polypropylene (PP)
Condition # 1 = 40 lbs/3000 sq. ft Kraft paper laminated to 25 micron film
of PVOH
Condition # 2 = 40 lbs/3000 sq. ft Kraft paper coated one side with Aqueous
PVOH on flooded nip size press @ 11% solids.
Condition # 3 = 40 lbs/3000 sq. ft Kraft paper coated one side with Aqueous
PVOH on flooded nip size press @ 24% solids.

| | | | | | Condition2 | | Condition3 | |
|---|---|---|---|---|---|---|---|---|
| | | | | Condition1 | 40 lbs | | 40 lbs | |
| | | | | 40 lbs w/ | w/ aqueous | | w/ aqueous | |
| | | | Conventional | 25 micron | PVOH (11% | | PVOH (24% | |
| | | Tappi | pet food bag | PVOH film | solids) coated | | solids) coated | |
| Test | Units | Test # | liner | (Hydropol) | 1 side | | 1 side | |
| Basis weight | lbs/3000 | Tappi | 51 | 67.9 | 42 | | 43 | |
| | sq. ft | T-410 | | | | | | |
| Tensile MD | lbf/in. | Tappi | 27.6 | 48 | 37.8 | | 40.3 | |
| | | T-494 | | | | | | |
| Tensile CD | lbf/in. | Tappi | 14 | 25 | 18.8 | | 17.4 | |
| | | T-494 | | | | | | |
| Stretch CD | % | Tappi | 4.2 | 3.6 | 4 | | 4.5 | |
| | | T-494 | | | | | | |
| Stretch MD | % | Tappi | 2.9 | 2.5 | 2.3 | | 2.1 | |
| | | T-494 | | | | | | |
| Mullen | psi | Tappi | 39.9 | 57.2 | 45.6 | | 48.5 | |
| | | T-403 | | | | | | |
| Tear CD | Grams | Tappi | 139 | 189 | 76 | | 73.2 | |
| | Force | T-414 | | | | | | |
| Tear MD | Grams | Tappi | 88 | 108 | 65.6 | | 67.6 | |
| | Force | T-414 | | | | | | |
| Creased | Time | Internal | Greater than | Greater | 1 | hour | 6 | hours |
| Accelerated | until >5% | test | 14 days | than 14 | | | | |
| Pet Food | failure | | | days | | | | |
| test | | | | | | | | |
| Tappi | time | Tappi | Greater than | Greater than | 30 | seconds | 60 | Seconds |

| Turpentine | | T454 | 24 hours | 24 hours | | |
|---|---|---|---|---|---|---|
| Kit level | 3M Kit # | Tappi | 12 | 12 | 5 | 10 |
| Coated side | | T559 | | | | |
| Recyclability | % Yield | EN 13430 | Not | 99 | Have not tested | |
| | after | | recyclable | | | |
| | screening | | | | | |
| | Visual | | Not | 5 | | |
| | Aspect of | | recyclable | | | |
| | Handsheets | | | | | |
| | Recyclability | | Not | Recyclable | | |
| | assessment | | recyclable | | | |
| OTR | cc/m² · day | ASTM | Did not test | 5.5 | did not test | did not test |
| (cc/m² · day) | | | | | | |
| 23° C. 50% | | | | | | |
| HR | | | | | | |
| Heat Seal | | ASTM | 250 | 400 | Dose not | Dose not |
| Temp | | F2029 | | | heat seal | heat seal |

As such, exemplary example composites 10 were prepared with kraft paper laminated with a 25 micron PVOH film 14. Comparative examples (Conditions 2 and 3 in Table 2) were prepared with the same kraft paper coated/impregnated with aqueous PVOH of similar degree of hydrolysis on one or both sides. The comparative examples of Conditions 2 and 3 which were impregnated with PVOH did not have the same strength properties or grease resistance as composites 10, and thus would not be suitable for use as an inner liner in pet food bags. The comparative examples of Conditions 2 and 3 showed lower tear strength and stretch compared to the exemplary example composite 10 (tear strength can be important in the end use application as the pet food bag is typically folded), and also showed lower grease resistance. It is noted that the maximum coat weight one could achieve by impregnating with aqueous PVOH is around 3 lbs/3000 ft² (e.g., 4.9 gsm). A big advantage to using a laminated or extruded additional layer of PVOH is that one can achieve much higher basis weights of a PVOH layer, which results in a stronger and more grease-resistant media/composite. Such types of basis weights would not be possible by impregnating PVOH by for example, using a size press.

The internal accelerated pet food test procedure (in Tables 1 and 2-“Creased Accelerated Pet Food test”) is described as follows. Test Requirements: 5 lb roller; Oven that can be set at 165° F. for several days; Pet Food-Hill's Science Diet Chicken recipe Dry Kitten Food 19% fat; Overhead Transparency with 4″×4″ grid printed on it (100 squares). Steps for accelerated pet food test:

Step 1: Turn on oven at 165° F.

Step 2: Cut samples to 4″×4″. Crease sample in the MD and CD direction. Lightly creased by hand and then went over the crease with a weighted roller (5 lb roller).

Step 3: Place two samples with Coated side up, and two samples with coated side down. Utilize untreated Kraft paper below for an indicator paper.

Step 4: Place 33 kibbles of pet food on each sample inside 3″ rings.

Step 5: Place samples in the oven with a 2 KG weight on top of the pet food.

Step 6: Check for staining/take pictures for 2 weeks at regular time intervals (at least once per day). Place transparency over blotter paper and count number of squares that are stained. Record time (number of hours) vs. number of squares stained (each square is 1%).

### EXAMPLE 3

### Recyclability Assessment

The objective was to test the recyclability of the 40 lbs Natural Kraft paper having the 25 micron PVOH film.

Background for recyclability assessment: Recyclability tests are referring to European directive 94/62/EC “packaging and packaging wastes,” and following the standard EN 13430 “Packaging-requirements for packaging recoverable by material recycling.”

To assess the recyclability of a product, three criteria should be considered: (1) Make sure that the design of the finished packaging contains a certain percentage of the packaging material that can be claimed to be recyclable. To be a secondary material for the paper industry, the packaging should be made with a minimum of 50% of cellulosic fibers; (2) Full control on the selection of raw materials to ensure that recycling processes are not negatively affected. In other words, packaging components should be compatible with known, relevant and industrially available recycling technologies; and (3) Recycled fibers should not impair paper quality manufactured with these recycled fibers.

40 lbs Natural Kraft with 25 micron PVOH film Recyclability's Assessment: The internal recyclability was compliant with the European Norm EN 13430 and followed a Protocol designed by the French Centre for Paper (CTP): the cellulosic fibers content was above 50% and met the pre-requisite for paper recycling; the recyclability test was made on A4 samples before further converting and/or printing process; and the recycling yield (rate of recovered material) was 99%.

TABLE 3
Recyclability test results: The composite tested was a
40 lbs Natural Kraft paper with a 25 micron PVOH film:

| | |
|---|---|
| Pulping (disintegration): | A few small pieces |
| individualize fibers/ | Big foam formation |
| pulpable suspension | std disintegrator, |
| | 15 min. 160000 trs |
| Yield after screening: | 99% |
| Yield (%) = “accepted” | |
| (100 - % of reject) | |
| Visual aspect of handsheets: | 5 |
| Quantify with a range of 1 to 5: | |
| 1- Fiber clumps visible; low quality handsheet; | |
| 5- no visible clumping of fibers or lumps | |
| Recyclability assessment | Recyclable |
| (derived from EN 13430) | |
| Drying in oven | No |

This disclosure further encompasses the following aspects.

Aspect 1. A composite configured for a food container comprising a recyclable composite comprising a paper substrate and a dissolvable polymer layer on the paper substrate; wherein the recyclable composite is configured and dimensioned to be positioned relative to a food container vessel for use with the food container vessel, the recyclable composite suitable for coming into contact with food.

Aspect 2. The composite of aspect 1, wherein the dissolvable polymer layer comprises at least one of polyvinyl alcohol or plasticized plant starch

Aspect 3. The composite of any one or more of the preceding aspects, wherein the dissolvable polymer layer is a laminated layer or an extruded layer.

Aspect 4. The composite of any one or more of the preceding aspects, wherein the recyclable composite is attached to one or more additional layers of the food container vessel, the one or more additional layers comprising paper.

Aspect 5. The composite of any one or more of the preceding aspects, wherein the recyclable composite is grease resistant and heat sealable, and meets U.S. FDA requirements 21 CFR 176.170 and 21 CFR 176.180 for direct food contact.

Aspect 6. The composite of any one or more of the preceding aspects, wherein the paper substrate comprises at least 50 weight % cellulosic fibers.

Aspect 7. The composite of any one or more of the preceding aspects, wherein the paper substrate has a basis weight of from about 30 grams per square meter (gsm) to about 100 gsm, preferably 40 to 70 gsm, more preferably 40 to 50 gsm.

Aspect 8. The composite of any one or more of the preceding aspects, wherein the dissolvable polymer layer has a thickness of from about 1 micron to about 40 microns, preferably 10 to 30 microns, more preferably 20 to 28 microns.

Aspect 9. The composite of any one or more of the preceding aspects, wherein the dissolvable polymer layer is warm water soluble at 40° C.

Aspect 10. The composite of any one or more of the preceding aspects, wherein the recyclable composite is re-pulpable at 40° C. or higher.

Aspect 11. The composite of any one or more of the preceding aspects, wherein the dissolvable polymer layer is biodegradable and water soluble.

Aspect 12. The composite of any one or more of the preceding aspects, wherein the dissolvable polymer layer is directly attached to the paper substrate.

Aspect 13. The composite of any one or more of the preceding aspects, wherein the food container vessel is a dry food packaging container vessel.

Aspect 14. The composite of any one or more of the preceding aspects, wherein the dissolvable polymer layer has a basis weight of from about 10 to 60 gsm, preferably 15 to 45 gsm.

Aspect 15. The composite of any one or more of the preceding aspects, wherein the dissolvable polymer layer is soluble in 60° C. tap water in less than 60 seconds.

Aspect 16. The composite of any one or more of the preceding aspects, wherein the dissolvable polymer layer comprises polyvinyl alcohol, the polyvinyl alcohol comprising partially hydrolyzed polyvinyl acetate with a degree of hydrolysis between 70% to 95%, preferably between 75% to 92%.

Aspect 17. The composite of any one or more of the preceding aspects, wherein the recyclable composite is oil and grease resistant, and passes the creased accelerated pet food test.

Aspect 18. The composite of any one or more of the preceding aspects, wherein the recyclable composite is recyclable according to EN13430.

Aspect 19. The composite of any one or more of the preceding aspects, wherein the recyclable composite is free of fluoro-chemicals and biaxially oriented polypropylene.

Aspect 20. The composite of any one or more of the preceding aspects, wherein the recyclable composite is oil and grease resistant at Kit Test Level 12 or above, as tested by TAPPI T559.

Aspect 21. The composite of any one or more of the preceding aspects, wherein the dissolvable polymer layer has an oxygen transmission rate of less than 10 cm³/m²/day at 23° C. and 50% relative humidity.

Aspect 22. The composite of any one or more of the preceding aspects, wherein the recyclable composite comprises at least one fold, the at least one fold resistant to grease.

Aspect 23. The composite of any one or more of the preceding aspects, wherein the paper substrate is fabricated from Kraft pulp having 100% cellulose fibers.

Aspect 24. The composite of any one or more of the preceding aspects, wherein the food container vessel defines an inner cavity, the recyclable composite configured and dimensioned to be positioned proximal to the inner cavity; and wherein the food container vessel is a pet food bag, the pet food bag configured and dimensioned to house pet food, the pet food comprising grease or oil.

Aspect 25. A method for fabricating a composite suitable for a food container comprising providing a dissolvable polymer layer on a paper substrate to define a recyclable composite; wherein the recyclable composite is configured and dimensioned to be positioned relative to a food container vessel for use with the food container vessel, the recyclable composite suitable for coming into contact with food.

Aspect 26. The method of aspect 25, wherein providing the dissolvable polymer layer on the paper substrate to define the recyclable composite comprises laminating or extruding the dissolvable polymer layer directly on the paper substrate.

Aspect 27. The method of any one of aspect 25 or aspect 26, wherein the dissolvable polymer layer comprises polyvinyl alcohol, the polyvinyl alcohol comprising partially hydrolyzed polyvinyl acetate with a degree of hydrolysis between 70% to 95%, preferably between 75% to 92%.

Aspect 28. The method of any one of aspects 25 to 27 further comprising positioning the recyclable composite relative to the food container vessel.

Aspect 29. The method of any one of aspects 25 to 28, wherein the food container vessel defines an inner cavity; and further comprising positioning the recyclable composite proximal to the inner cavity of the food container vessel; and wherein the food container vessel is a pet food bag, the pet food bag configured and dimensioned to house pet food, the pet food comprising grease or oil.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

Although the composites, systems and methods of the present disclosure have been described with reference to exemplary embodiments thereof, the present disclosure is not limited to such exemplary embodiments and/or implementations. Rather, the composites, systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

1. A composite configured for a food container comprising:
a recyclable composite comprising a paper substrate and a dissolvable polymer layer on the paper substrate;
wherein the recyclable composite is configured and dimensioned to be positioned relative to a food container vessel for use with the food container vessel, and the recyclable composite is suitable for coming into contact with food.

2. The composite of claim 1, wherein the dissolvable polymer layer comprises at least one of polyvinyl alcohol or plasticized plant starch.

3. The composite of claim 1, wherein the dissolvable polymer layer is a laminated layer or an extruded layer.

4. The composite of claim 1, wherein the recyclable composite is attached to one or more additional layers of the food container vessel, the one or more additional layers comprising paper.

5. The composite of claim 1, wherein the recyclable composite is grease resistant and heat sealable, and meets U.S. FDA requirements 21 CFR 176.170 and 21 CFR 176.180 for direct food contact.

6. The composite of claim 1, wherein the paper substrate comprises at least 50 weight % cellulosic fibers.

7. The composite of claim 1, wherein the paper substrate has a basis weight of from about 30 grams per square meter (gsm) to about 100 gsm, preferably 40 to 70 gsm, more preferably 40 to 50 gsm.

8. The composite of claim 1, wherein the dissolvable polymer layer has a thickness of from about 1 micron to about 40 microns, preferably 10 to 30 microns, more preferably 20 to 28 microns.

9. The composite of claim 1, wherein the dissolvable polymer layer is warm water soluble at 40° C. or soluble in 60° C. tap water in less than 60 seconds.

10. (canceled)

11. (canceled)

12. The composite of claim 1, wherein the dissolvable polymer layer is directly attached to the paper substrate.

13. (canceled)

14. The composite of claim 1, wherein the dissolvable polymer layer has a basis weight of from about 10 to 60 gsm, preferably 15 to 45 gsm.

15. (canceled)

16. The composite of claim 1, wherein the dissolvable polymer layer comprises polyvinyl alcohol, the polyvinyl alcohol comprising partially hydrolyzed polyvinyl acetate with a degree of hydrolysis between 70% to 95%, preferably between 75% to 92%.

17. The composite of claim 1, wherein the recyclable composite is oil and grease resistant, and passes the creased accelerated pet food test.

18. The composite of claim 1, wherein the recyclable composite is recyclable according to EN13430.

19. The composite of claim 1, wherein the recyclable composite is free of fluoro-chemicals and biaxially oriented polypropylene.

20. (canceled)

21. The composite of claim 1, wherein the dissolvable polymer layer has an oxygen transmission rate of less than 10 cm³/m²/day at 23° C. and 50% relative humidity.

22. The composite of claim 1, wherein the recyclable composite comprises at least one fold, the at least one fold resistant to grease.

23. (canceled)

24. The composite of claim 1,
wherein the food container vessel defines an inner cavity, the recyclable composite configured and dimensioned to be positioned proximal to the inner cavity; and
wherein the food container vessel is a pet food bag, the pet food bag configured and dimensioned to house pet food, the pet food comprising grease or oil.

25. A method for fabricating a composite suitable for a food container comprising:
providing a dissolvable polymer layer on a paper substrate to define a recyclable composite;
wherein the recyclable composite is configured and dimensioned to be positioned relative to a food container vessel for use with the food container vessel, the recyclable composite suitable for coming into contact with food.

26.-28. (canceled)

29. The method of claim 25, wherein the food container vessel defines an inner cavity; and further comprising
positioning the recyclable composite proximal to the inner cavity of the food container vessel; and
wherein the food container vessel is a pet food bag, the pet food bag configured and dimensioned to house pet food, the pet food comprising grease or oil.
